(19) United States
(12) Patent Application Publication
(10) Pub. No.: US 2026/0236668 A1
(43) Pub. Date: Aug. 13, 2026

(54) ARTIFICIAL INTELLIGENCE BASED OPERATION METHOD OF ELECTRONIC APPARATUS FOR AUTOMATICALLY GENERATING PRESENTATION DATA BY ANALYZING VIDEO

(71) Applicant: INDUSTRY ACADEMIC COOPERATION FOUNDATION, HALLYM UNIVERSITY, Chuncheon-si (KR)

(72) Inventors: Sung Mi PARK, Seoul (KR); Hyun Jung AN, Chuncheon-si (KR)

(73) Assignee: INDUSTRY ACADEMIC COOPERATION FOUNDATION, HALLYM UNIVERSITY, Chuncheon-si (KR)

(21) Appl. No.: 19/062,571

(22) Filed: Feb. 25, 2025

(30) Foreign Application Priority Data
Feb. 13, 2025 (KR) 10-2025-0018808

(51) Int. Cl. G06F 40/166; G06T 11/60; G06V 10/62; G06V 10/75; G06V 10/82; G06V 10/94; G06V 20/40; G06V 20/62; G06V 30/19; G06V 30/262; G10L 15/26; G10L 15/30; G10L 25/57

(52) U.S. Cl. CPC G06F 40/166; G06T 11/60; G06V 10/75; G06V 10/95; G06V 20/47; G06V 20/635; G06V 30/19007; G06V 30/274; G10L 15/26; G10L 15/30; G10L 25/57; G06T 2200/24; G06V 10/62; G06V 10/82

(57) ABSTRACT

Disclosed is an operation method of an electronic apparatus. The operation method includes: extracting a plurality of image frames and audio data constituting a video; acquiring a first text for each image frame from the plurality of image frames; selecting at least one main image frame among the plurality of image frames based on the first text; acquiring a second text into which the audio data is converted for each time interval constituting the video; and generating presentation data constituted by at least one slide based on the main image frame, a first text matching the main image frame, and a second text matching a time interval including the main image frame.

### CROSS-REFERENCE TO RELATED APPLICATION

This application claims the benefit of and priority to Korean Patent Application No. 10-2025-0018808, filed on Feb. 13, 2025, the entire disclosure(s) of which is hereby incorporated herein by reference in its entirety.

### BACKGROUND

### Field

The present disclosure relates to an operation method of an electronic apparatus or system which analyzes a video, and more particularly, to an operation method of automatically generating visual presentation data based on a text extracted from a video.

### Description of Related Art

Project name: 2024 Local University Revitalization (Glocal University)-062
Period: Mar. 1, 2024 to Feb. 28, 2025

In recent years, as video-based contents such as online lectures, non-face-to-face classes, and video conferences have become widespread, the demand for recycling or sharing video has increased through the immediate conversion of video into documents.

However, in order to summarize existing video lectures with separate summarized documents or visual materials (ex. Presentation data such as PowerPoint data), efforts such as watching the lecture contents directly, taking notes of the text, and capturing and inserting important images were required.

In this regard, some voice recognition and automatic summary technology for business convenience have emerged, but a series of automation systems that integrate into one flow from video division to image analysis, text summary, and automatic configuration of visual data (presentation data) are limited.

### SUMMARY

The present disclosure provides an operation method of an electronic apparatus providing an integrated process that extracts core sections and images, converts voice into text, and summarizes necessary information to automatically generate visual presentation data.

The objects of the present disclosure not limited to the above-mentioned objects, and other objects and advantages of the present disclosure that are not mentioned can be understood by the following description, and will be more clearly understood by embodiments of the present disclosure. Further, it will be readily appreciated that the objects and advantages of the present disclosure can be realized by means and combinations shown in the claims.

In an aspect, provided is an operation method of an electronic apparatus, which includes: extracting a plurality of image frames and audio data constituting a video; acquiring a first text for each image frame from the plurality of image frames; selecting at least one main image frame among the plurality of image frames based on the first text; acquiring a second text into which the audio data is converted for each time interval constituting the video; and generating presentation data constituted by at least one slide based on the main image frame, a first text matching the main image frame, and a second text matching a time interval including the main image frame.

In the acquiring of the first text, each of the plurality of image frames may be input into a captioning model to acquire a first text corresponding to each image frame.

In the selecting of the main image frame, the first text matching each of the plurality of image frames may be analyzed based on reference data acquired according to a user input to calculate an importance of each of the plurality of image frames, and at least one main image frame among the plurality of image frames may be selected based on the importance.

The generating of the presentation data may include acquiring a comprehensive text based on the first text and the second text matching the at least one main image frame; respectively, dividing the comprehensive text into at least one sub text; and generating slide configuration information including at least one slide matching the at least one sub text, respectively.

In this case, in the dividing of the comprehensive text into at least one sub text, the comprehensive text may be divided into a plurality of sub texts based on a theme relevancy, a semantic connectivity, and a similarity of each sentence constituting the comprehensive text.

Further, in the generating of the slide configuration information, a main sentence may be extracted from a sub text matching each slide, at least one main image frame related to the sub text matching each slide may be selected, and each slide may be arranged according to an order of each of at least one sub text within the comprehensive text, and each slide may be configured based on the extracted main sentence and the selected main image frame.

At this time, the operation method of an electronic apparatus may include providing feedback information for the slide configuration information based on the number of images within each slide according to the slide configuration information.

In another aspect, provided is an operation method of an electronic apparatus performing communication with an image captioning server and a voice recognition server, which includes: extracting a plurality of image frames and audio data constituting a video; transmitting the plurality of image frames to the image captioning server, and acquiring a first text for each image frame according to a result of captioning performed by the image captioning server; selecting at least one main image frame among the plurality of image frames based on the first text; transmitting the audio data to the voice recognition server, and acquiring a second text into which the audio data is converted for each a time interval constituting the video according to a result of voice recognition performed by the voice recognition server; and generating presentation data constituted by at least one slide based on the main image frame, a first text matching the main image frame, and a second text matching a time interval including the main image frame.

The operation method of the electronic apparatus according to the present disclosure has an advantage in that in production of presentation data based on video contents, workforce and costs consumed in the production of the presentation data can be significantly reduced. For example, there is an advantage in that a lecture data production process for a lecture video becomes very simple.

Moreover, in the operation method of the electronic apparatus according to the present disclosure, unnecessary scenes or repeated sections are excluded, presentation data is configured based on core contents to enhance readability and an information delivery effect, and user customized keywords or importance can be applied, so the operation method of the electronic apparatus can be easily applied to videos corresponding to various fields and purposes.

### BRIEF DESCRIPTION OF THE DRAWING

FIG. 1 is a block diagram for describing a configuration of an electronic apparatus according to an embodiment of the present disclosure.

FIG. 2 is a diagram for describing a process in which the electronic apparatus generates presentation data based on a text acquired by analyzing each element in a video according to an embodiment of the present disclosure.

FIG. 3 is a flowchart for describing a process in which the electronic apparatus selects a primary image frame according to an embodiment of the present disclosure.

FIG. 4 is a diagram for describing a specific embodiment in which the electronic apparatus generates the presentation data according to an embodiment of the present disclosure.

FIG. 5 is a block diagram for describing a configuration and an operation of an electronic apparatus which performs communication with at least one external server according to an embodiment of the present disclosure.

### DETAILED DESCRIPTION

The embodiments may have various transformations and various embodiments and specific embodiments will be illustrated in the drawings and described in detail in the detailed description. However, it should be understood to limit the scope for a particular embodiment, but to include various modifications, equivalents, and/or alternatives of the embodiment of the present disclosure. In connection with the description of the drawings, similar reference numerals may be used for similar components.

In describing the present disclosure, a detailed explanation of known related technologies may be omitted to avoid unnecessarily obscuring the subject matter of the present disclosure.

In addition, the following embodiments may be transformed into several different forms, and the scope of the technical idea of the present disclosure is not limited to the following embodiment. On the contrary, the embodiments are provided to be further and complete, and to fully convey the technical idea of the present disclosure to those skilled in the art.

Terms used in the present disclosure are used only to describe specific embodiments, and are not intended to limit the scope of rights. A singular form includes a plural form if there is no clearly opposite meaning in the context.

In the present disclosure, expressions such as “have”, “can have”, “include” or “can include”, etc., indicate the presence of the corresponding features (e.g., components such as, numerical value, function, operation, or element), and the presence of an additional feature is not excluded.

In the present disclosure, expressions such as “A or B”, “at least one of A and/or B”, or “one or more of A or/and B” may include all possible combinations of items listed together. For example, at least one of “A or B”, “at least one of A and B”, or “at least one of A or B” may refer to all cases of (1) including at least one A, (2) including at least one B, or (3) including at least one A and at least one B.

Expressions such as “first” or “second” may modify various components regardless of an order or importance, and will be used only to distinguish one component from another component, but does not limit the corresponding components.

When any component (e.g., first component) is referred to as being “(operatively or communicatively) coupled with/to” or “connected to” the other component (e.g., second component), it will be appreciated that any component may be directly coupled with/to the other component or coupled with/to the other component through another component (e.g., third component).

On the other hand, when any component (e.g., first component) is mentioned as “direct coupled with/to” or “directly connected” to the other component (e.g., second component), it may be appreciated that another component (e.g., third component) does not exist between any component and the other component.

An expression “configured to” used in the present disclosure may be used interchangeably with, for example, “suitable for,” “having the capacity to,” “designed to”, “adapted to”, “made to”, or “capable of” depending on a situation. A term “configured to” may not particularly mean only ‘specifically designed to” in terms of hardware.

Instead, in some situations, an expression “device configured to” may mean that the device “capable of” together with other devices or parts. For example, a phrase “processor 130 configured to perform A, B, and C” may mean a dedicated processor 130 (e.g., an embedded processor 130) for performing the operation, or a generic-purpose processor (e.g., a CPU or application processor) capable of performing the corresponding operations by executing one or more software programs stored in a memory device.

In an embodiment, a “module” or “part” performs at least one function or operation, and may be implemented by hardware or software, or by a combination of hardware and software. Further, a plurality of “modules” or a plurality of “parts” may be integrated into at least one module and implemented with at least one processor 130, except for a “module” or “part” that needs to be implemented with specific hardware.

On the other hand, various elements and areas in drawings are schematically drawn. Therefore, the technical idea of the present disclosure is not limited by a relative size or interval drawn on the accompanying drawings.

The embodiments of the present disclosure will be described more fully hereinafter with reference to the accompanying drawings, in which embodiments of the present disclosure are shown.

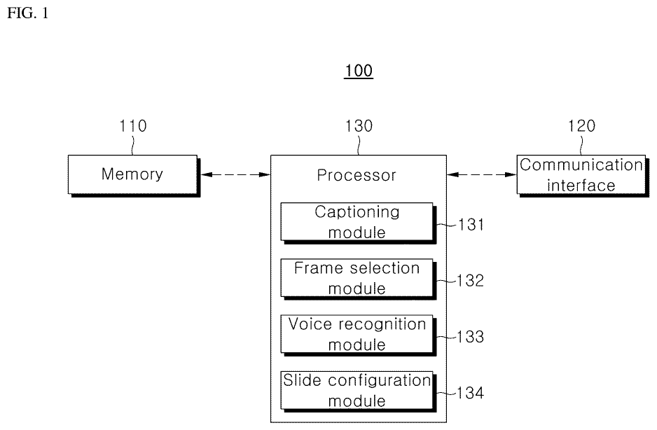

FIG. 1 is a block diagram for describing a configuration of an electronic apparatus according to an embodiment of the present disclosure. The electronic apparatus 100 may correspond to an apparatus or system constituted by at least one computer. The electronic apparatus 100 may be implemented as a server, and may also be implemented as various terminal devices including a smartphone, a desktop PC, a tablet PC, a wearable device, a VR/AR device, etc.

Referring to FIG. 1, the electronic apparatus 100 may include a memory 110, communication interfaces 120 and 120, and processors 130 and 130.

The memory 110 transitorily or non-transitorily stores various programs or data, and delivers the stored information to the processor 10 according to a call of the processor 130. Further, the memory 110 may store various information required for a computation, processing, or control operation of the processor 130 in an electronic format.

The memory 110 may include, for example, at least one of a main memory device and an auxiliary memory device. The main memory device may be implemented by using a semiconductor storage medium such as a ROM and/or a RAM. The ROM may include, for example, a general ROM, EPROM, EEPROM, and/or MASK-ROM. The RAM may include, for example, a DRAM and/or an SRAM. The auxiliary memory device may be implemented by using optical media such as a secure digital (SD) card, a solid state drive (SSD), a hard disc drive (HDD0, a magnetic drum, a compact disk (CD), a DVD, or a laser disc, and at least one storage medium capable of permanently or semi-permanently storing data, such as a magnetic tape, an optic-magnetic disc, and/or a floppy disc.

The memory 110 may include a captioning model corresponding to an artificial intelligence model for performing captioning of extracting a text from an image, a language processing model for calculating a similarity between texts based on natural language processing for a text or selecting a main text, a voice recognition model for recognizing the text from audio data, etc., but is not limited thereto.

The communication interface 120 may include at least one of a wireless communication interface, a wired communication interface, and an input/output interface.

The wireless communication interface may perform communication with various external apparatuses by using a wireless communication technology or a mobile communication technology. The wireless communication technology may include, for example, Bluetooth, Bluetooth low energy, CAN communication, Wi-Fi, Wi-Fi Direct, ultrawide band (UWB), Zigbee, infrared data association (IrDA), or near field communication (NFC), and the mobile communication technology may include 3GPP, Wi-Max, long term evolution (LTE), 5G, etc.

The wireless communication interface may implemented by using an antenna which may transmit an electromagnetic wave to the outside or receive an electromagnetic wave delivered from the outside, a communication chip, and a board.

The wired communication interface may perform communication with various apparatuses based on a wired communication network. Here, the wired communication network may be implemented by using, for example, a physical cable such as a pair cable, a coaxial cable, an optical fiber cable, or an Ethernet cable.

The input/output interface may be provided to be coupled with/to another apparatus provided separately from the electronic apparatus, for example, an external storage apparatus. For example, the input/output interface may be a universal serial bus (USB), and besides, it may be any one interface of a high definition multimedia interface (HDMI), mobile high-definition link (MHL), a universal serial bus (USB), a display port (DP), a thunderbolt, a video graphics array (VGA) port, an RGB port, a D-subminiature (SUB), and a digital visual interface (DVI). The input/output interface may input/output at least one of an audio signal and a video signal. According to an implementation example, the input/output interface may include a port inputting/outputting only the audio signal and a port inputting/outputting only the video signal as separate ports, or may be implemented as one port which inputs/outputs both the audio signal and the video signal.

The electronic apparatus 100 is not limited to one communication interface 120 for performing one scheme of communication connection, and may include a plurality of communication interfaces 120 for performing communication connections in a plurality of schemes.

When the electronic apparatus 100 is implemented as a server, the electronic apparatus 100 communicates with at least one user terminal (e.g., a smartphone, a desktop PC, a notebook PC, a tablet PC, etc.) through at least one webpage or application to perform various functions to be described later.

The processor 130 controls all operations of the electronic apparatus. Specifically, the processor 130 is connected to components of the electronic apparatus 100 including the memory 110 as described above, and executes at least one instruction stored in the memory 110 to control all operations of the electronic apparatus. In particular, the processor 130 may be not only implemented as one processor, but also implemented as a plurality of processors.

The processor 130 may be implemented in various schemes. For example, one or more processors 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. One or more processors 130 may control one or any combination of other components of the electronic apparatus, and perform an operation or data processing for communication. One or more processors 130 may execute one or more programs or instructions stored in the memory. For example, one or more processors 130 execute one or more instructions stored in the memory to perform a method according to an embodiment of the present disclosure.

In embodiments of the present disclosure, the processor 130 may mean a system on chip (SoC) in which one or more processors 130 and other electronic parts are integrated, a single core processor, a multicore processor, or a core included in the single core processor or multicore processor, and here, the core may be implemented as the CPU, the GPU, the APU, the MIC, the DSP, the NPU, the hardware accelerator, or the machine learning accelerator, but the embodiments of the present disclosure is not limited thereto.

When the method according to an embodiment of the present disclosure includes a plurality of operations, the plurality of operations may be performed by one processor 130 or performed by a plurality of processors 130. For example, when a first operation, a second operation, and a third operation are performed by the method according to an embodiment, the first operation, the second operation, and the third operation may be all performed by a first processor, and the first operation and the second operation may be performed by the first processor (e.g., a generic-purpose processor) and the third operation may be performed by a second processor (e.g., an artificial intelligence dedicated processor).

One or more processors 130 may be implemented as the single core processor including one core, and implemented as one or more multicore processors including a plurality of cores (e.g., a homogeneous multicore or a heterogeneous multicore). When one or more processors 130 are implemented as the multicore processor, each of the plurality of cores included in the multicore processor may include a processor-in memory such as an on-chip memory, and a common cache shared by the plurality of cores may be included in the multicore processor 130. Further, each of the plurality of cores (or some of the plurality of cores) included in the multicore processor 130 may independently read and perform a program instruction for implementing the method according to an embodiment of the present disclosure, and all of the plurality of cores (or some of the plurality of cores) are linked to read and perform the program instruction for implementing the method according to an embodiment of the present disclosure.

When the method according to an embodiment of the present disclosure includes a plurality of operations, the plurality of operations may be performed by one core among the plurality of cores included in the multicore processor or performed by the plurality of cores. For example, when the first operation, the second operation, and the third operation are performed by the method according to an embodiment, the first operation, the second operation, and the third operation may be all performed by a first core included in the multicore processor, and the first operation and the second operation may be performed by the first core included in the multicore processor and the third operation may be performed by a second core included in the multicore processor.

Referring to FIG. 1, the processor 130 may control a captioning module 131, a frame selection module 132, a voice recognition module 133, a slide configuration module 134, etc. The modules may correspond to function-unit modules implemented as hardware and/or software.

The captioning module 131 is a component for extracting a first text from each of a plurality of image frames constituting a video. The video may correspond to various contents related to an education, training, and a task such as a lecture, a seminar, a meeting, etc., but besides, it may correspond to videos of various categories including a documentary, news, an interview, a movie, a game video, an animation, a variety show, sports, etc.

The captioning module 131 may input each image frame into a captioning model, and the captioning model extracts feature information of each image and converts the extracted feature information into a text to output a text (a first text). To this end, the captioning model may include at least one of a CNN, an RNN, and a transformer model, but is not limited thereto.

The frame selection module 132 is a module for selecting at least one main image frame among a plurality of image frames based on the first text of each image frame extracted by the captioning module 131. To this end, the frame selection module 132 may utilize reference data (e.g., a keyword, a prompt, etc.) set according to a user input. Specifically, the frame selection module 132 compares the first text of each image frame with the reference data through a language processing module to select at least one image frame having a highest similarity to the reference data as the main image frame. The language processing model may include at least one of a recurrent neural network (RNN), a transformer, a Bidirectional encoder representations from transformers (BERT), a long short-term memory (LSTM), and a generative pretrained transformer (GPT), but present disclosure is not limited thereto.

The voice recognition module 133 is a component that recognizes a voice of audio data included in the video. The voice recognition module 133 may acquire a second text by recognizing the voice for the audio data by using the voice recognition model. The voice recognition model may include an acoustic model for identifying a unit text (e.g., phoneme, syllable, etc.) by extracting a feature from the audio data, a language model for combining the identified unit text, etc., but the present disclosure is not limited thereto.

The slide configuration module 134 is a component for generating slide configuration information of presentation data constituted by at least one slide based on the main image frame, the first text extracted from the main image frame, and the second text extracted according to the voice recognition.

The slide may correspond to a unit page constituting the presentation data, and the presentation data may be constituted by a plurality of slides (a plurality of pages) which are continued in order. Each slide may be constituted by at least one image and at least one text, and for example, all presentation data may be opened by a scheme in which slides are provided one by one upon presentation.

The slide configuration module 134 may acquire a comprehensive text by integrating the first text and the second text, identify a plurality of sub texts by dividing the comprehensive text according to a content flow, and generate slide configuration information so that each sub text is included in the main image frame and one slide.

Hereinafter, an operation of the electronic apparatus 100 including the above-described components will be described in more detail.

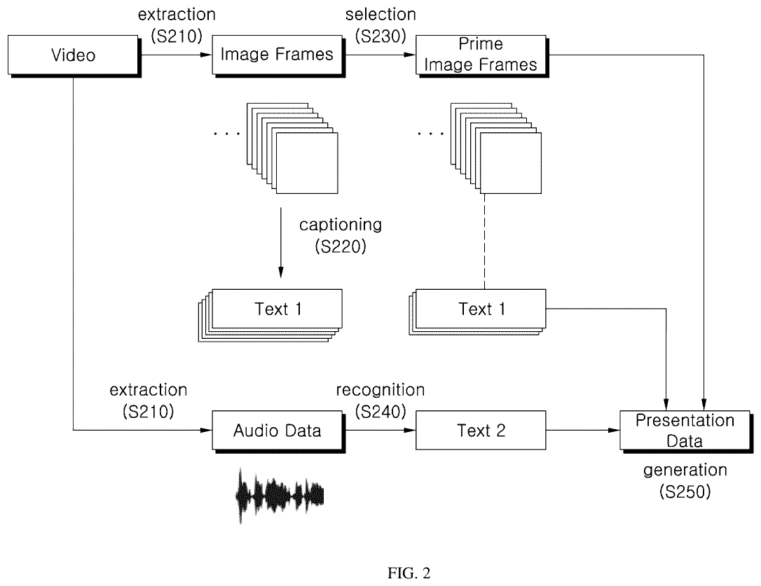

FIG. 2 is a diagram for describing a process in which the electronic apparatus generates presentation data based on a text acquired by analyzing each element in a video according to an embodiment of the present disclosure.

Referring to FIG. 2, first, the electronic apparatus 100 may extract a plurality of image frames and audio data constituting a video (S210). At this time, a video which becomes a target may also be selected according to a user input, and in this case, it is also possible to select only a partial time interval in the video other than one entire video file.

The electronic apparatus 100 may acquire a first text for each image frame from the plurality of image frames (S220). Specifically, the electronic apparatus 100 input each of the plurality of image frames into a captioning model through a captioning module 131 to acquire the first text corresponding to each image frame. Further, it is also possible that the electronic apparatus 100 performs an optical character recognition (OCR) function for each image frame to extract the first text included in the image frame.

At this time, the electronic apparatus 100 analyzes the first text of each image frame to select at least one main image frame among the plurality of image frames (S230). This process may be performed by the frame selection module 132, and the main image frame means an important image frame in generating presentation data.

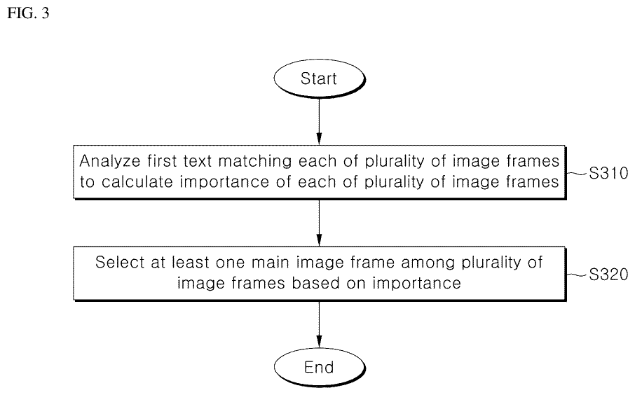

As an embodiment of process S230, referring to FIG. 3, the electronic apparatus 100 analyzes the first text matching each of the plurality of image frames based on reference data acquired according to the user input to calculate an importance of each of the plurality of image frames (S310). Reference data may correspond to a keyword or a prompt, but is not limited thereto.

Here, the electronic apparatus 100 compares the first text of each image frame with the reference data to calculate a similarity (e.g., a distance between vectors in which a text is converted), and calculate a higher importance as the similarity is higher, but the present disclosure is not limited thereto.

In addition, the electronic apparatus 100 may select at least one main image frame among the plurality of image frames based on the calculated importance (S320). For example, image frames in which the importance is equal to or higher than a threshold, or a predetermined number of image frames having a highest importance may be selected. As a related embodiment, at least one quantity item (the number of slides, the number of images, a capacity of an entire text, etc.) may be set according to the user input in regard to an amount of presentation data to be generated, and at this time, the above-described threshold or predetermined may also be set according to a value set for the quantity item. In general the above-described threshold or predetermined number may be set to be higher as the value of the quantity item is set to be higher.

Additionally, when the plurality of main image frames are selected, the electronic apparatus 100 may calculate a similarity between two or more main image frames which are directly adjacent to each other and have a time interval which is less than a predetermined time. To this end, at least one artificial intelligence model (e.g., CNN) for extracting feature information of an image may be utilized, and according to a result of comparing vector values constituting the feature information, as a difference is smaller, a similarity may be calculated to be larger. When the similarity is equal to or higher than a threshold similarity, the electronic apparatus 100 may set the two main image frames as one similar frame pair, and leave only one main image frame within the similar frame pair, and exclude the other one main image frame from the main image frame. Such a process is repeatedly performed even with respect to the remaining main image frames, and as a result, such a process may be continued until the similar frame pair (two main image frames which are directly adjacent to each other, have a time interval which is less than a predetermined time, and have a similarity which is equal to or higher than a threshold similarity) does not exist any longer.

At this time, the electronic apparatus 100 may select the main image frame having the highest importance (maintain the main image frame having the highest important as the main image frame) within the similar frame pair. However, when an importance difference is less than a predetermined numerical value, the electronic apparatus 100 may select one main image frame based on a similarity of each main image frame within the similar frame pair to another main image frame directly adjacent to each main image frame in an opposite direction. As a specific example, it is assumed that in a situation in which first, second, third, and fourth main image frames are sequentially selected according to the reference data initially, a second main image frame and a third main image frame are identified as the similar frame pair. In this case, the electronic apparatus 100 may compare a similarity between the second main image frame and the first main image frame with a similarity between the third main image frame and the fourth image frame, and select and leave only a main image frame corresponding to a lower similarity between the second main image frame and the third main image frame. According to the embodiments, there is an effect in that by preventing a situation in which main image frames having similar contents are unnecessarily selected and applied to the presentation data, overlapping or unnecessary lengths of contents within the presentation data may be prevented.

Meanwhile, referring to FIG. 2, the electronic apparatus 100 performs voice recognition for the audio data through the voice recognition module 133 to acquire a second text (S240). At this time, the electronic apparatus 100 may also acquire the second text in which the audio data is converted for each time interval constituting the video. At this time, initially, each time interval may be sequentially divided and set according to a unit time, but when audio data matching one sentence converted according to the voice recognition exists over two time intervals, at least time interval may be corrected by a scheme in which a time interval including a larger part of the corresponding audio data is extended to include all audio data.

In addition, the electronic apparatus 100 may generate presentation data constituted by at least one slide based on the main image frame, the first text matching the main image frame, and the second text matching the time interval including the main image frame (S250). This process may be performed through the slide configuration module 134.

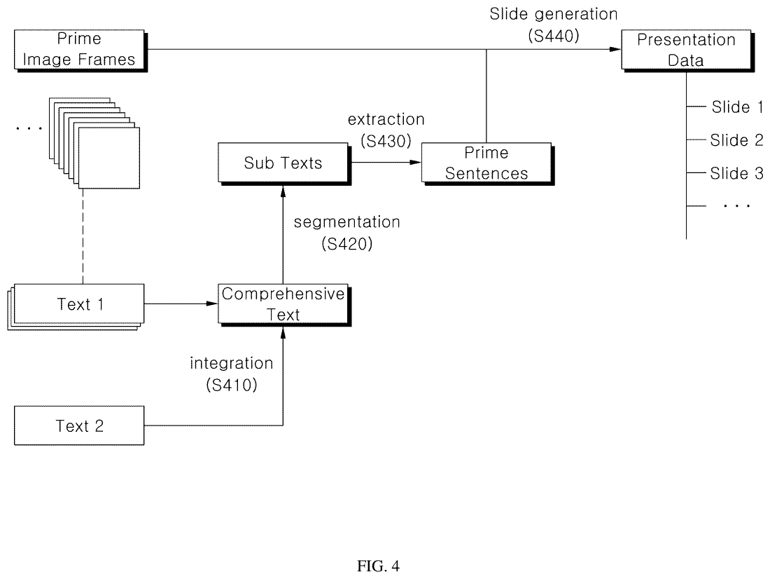

In this regard, FIG. 4 is a diagram for describing a specific embodiment in which the electronic apparatus generates presentation data according to an embodiment of the present disclosure.

Referring to FIG. 4, the electronic apparatus 100 may acquire a comprehensive text based on the first text and the second text matching at least one main image frame, respectively (S410).

Specifically, the electronic apparatus 100 may fuse the second text included in a time interval including each main image frame or a time interval closest to each main image frame with the first text matching each main image frame. For example, when the first main image frame is included in a first time interval and the second main image frame is included in a second time interval in order, a first-1 text of the first main image frame and a second-1 text extracted from audio data of the first time interval may be fused, and a first-2 text of the second main image frame and a second-2 text extracted from audio data of the second time interval may be fused.

In a fusion process, the electronic apparatus 100 may re-arrange each sentence so as to become the most natural context by using the above-described language processing model, and generate a conjunction between a sentence and a sentence according to a relationship between the sentences. At this time, the respective sentences may also be re-arranged so that sentences having a highest similarity are continued according to a semantic similarity between sentences, and a temporal order or a casual relationship is identified by the language processing model, and as a result, rearrangement for the sentences may also be performed.

Meanwhile, when there are two or more main image frames in one time interval, the electronic apparatus 100 may fuse both first texts of respective main image frames included in the same time interval and second texts corresponding to the time interval.

In addition, the electronic apparatus 100 lists the texts fused for each time interval according to an order of the time interval to acquire the comprehensive text.

Meanwhile, when the comprehensive text is acquired as such, the electronic apparatus 100 may divide the comprehensive text into at least one sub text (S420). Specifically, the electronic apparatus 100 may divide the comprehensive text into a plurality of sub texts based on at least one of a theme relevancy, a semantic connectivity, and a similarity of each sentence constituting the comprehensive text.

The theme relevancy is a concept indicating how each sentence is related to a specific theme, and the electronic apparatus 100 may group continued sentences in which a relevancy for a common theme is equal to or larger than a predetermined numerical value into the same sub text. To this end, in a process of calculating a relationship between the sentence and the theme, that is, the theme relevancy, a technique such as Latent Dirichlet Allocation (LDA), Non-Negative Matrix Factorization (NMF), etc., may be utilized, but the present disclosure is not limited thereto. In this case, similarities for themes of respective keywords constituting a sentence are integrated, so the theme relevancy may be calculated, and a theme relevancy for a plurality of themes may be identified with respect to one sentence.

The semantic connectivity is a concept indicating how well the sentences are semantically connected and includes a dependency between sentences, a context, etc. For example, the electronic apparatus 100 may calculate the dependency between the sentences according to the similarity between the sentences, and a conjunction included between the sentences, and calculate the semantic connectivity to be higher as the dependency is higher. When sentences in which the semantic connectivity is equal to or larger than a predetermined numerical value are connected to each other, the electronic apparatus 100 may group the sentences into the same sub text.

In relation to the similarity, when a similarity between sentences connected to each other is equal to or larger than a predetermined numerical value, the electronic apparatus 100 may group the corresponding sentences into the same sub text. To this end, a text embedding technique may be performed.

As an embodiment, the electronic apparatus 100 may calculate an item value to which at least one of the theme relevancy, the semantic connectivity, and the similarity is applied, with respect to two sentences which are sequentially continued within the comprehensive text, and may also group two corresponding sentences into the same sub text on a premise that the calculated item value is equal to or larger than a predetermined numerical value.

When the comprehensive text is divided into at least one sub text according to at least one of the embodiments, the electronic apparatus 100 may generate slide configuration information including at least one side matching each of at least one sub text.

Specifically, the electronic apparatus 100 may generate each slide including a main sentence and a main image frame, which will be described below.

Referring to FIG. 4, the electronic apparatus 100 may extract the main sentence from the sub text matching each slide (S430). In this case, the electronic apparatus 100 may also extract a main sentence including the most important word by calculating an importance of each word by a technique such as a term frequency-inverse document frequency (TF-IDF), and extract a sentence having a highest similarity (an average) for other sentences as the main sentence according to the similarity between the sentences.

Further, the electronic apparatus 100 may select at least one main image frame related to the sub text matching each slide. At this time, the main image frame may be selected, which matches the first text utilized in a process in which a sub text (a part of the comprehensive text) is generated (fusion process).

In addition, the electronic apparatus 100 may arrange each slide according to an order of each of at least one sub text within the comprehensive text, and configure each slide based on the extracted main sentence and the selected main image frame. That is, at least one slide may be generated for each sub text, and the main sentence and the main image frame which match each sub text may constitute contents of the slide (S440).

Meanwhile, the electronic apparatus 100 may also provide feedback information for the slide configuration information based on the number of images within each slide according to the slide configuration information. For example, when more sentences are extracted compared to the number of main image frames, a frequency of the image within each slide may become lower, while when fewer main sentences are extracted compared to the number of main image frames, the frequency of the image within each slide may become higher.

When an appropriate frequency range which is preset or set according to the user input exists, the electronic apparatus 100 may also provide, to a user, feedback information of recommending addition of the image or removal of at least one image (main image frame) only when the set appropriate frequency range deviates from the appropriate frequency range.

Meanwhile, according to an embodiment, the electronic apparatus 100 may also perform a function by interlocking with at least one external server in each operation (e.g., S210 to S250) described above.

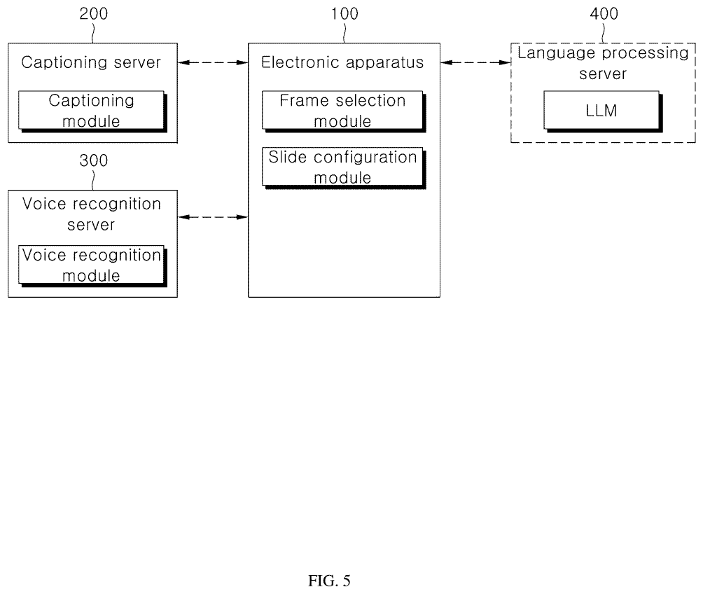

In this regard, FIG. 5 is a block diagram for describing a configuration and an operation of an electronic apparatus which performs communication with at least one external server according to an embodiment of the present disclosure.

Referring to FIG. 5, the electronic apparatus 100 includes only a frame selection module and a slide configuration module, and a captioning process may be performed through a captioning server 200 including a captioning module and a captioning model, and a voice recognition process may be performed through a voice recognition server 300 including a voice recognition module and a voice recognition model.

Further, when the electronic apparatus 100 does not possess its own language processing model, the electronic apparatus 100 may compare a first text (a captioning result) of each image frame with reference data by using a language processing model (e.g., large language model (LLM) included in a separate language processing server 400 to select the main image frame or perform a series of processes (e.g., S410, S420, S430, etc.) constituting the slide by using the language processing model included in the language processing server 400.

Meanwhile, various embodiments described above may be implemented by combining two or more embodiments as long as the embodiments do not conflict or contradict each other.

Specifically, a plurality of operations, steps, and components for implementing one embodiment may be implemented by a scheme in which another embodiment is embodied, or a last operation and a last step are followed by an operation and a step of another embodiment, but the present disclosure is not limited thereto.

Meanwhile, computer instructions or computer programs for performing processing operations according to various embodiments of the present disclosure described above may be stored in a non-transitory computer-readable medium. The computer instructions or computer programs stored in such non-transitory computer-readable medium, when executed by a processor of a specific device, cause the specific device to perform processing operations according to the various embodiments described above.

The non-transitory computer readable medium is not a medium that stores data therein for a while, such as a register, a cache, a memory, or the like, but means a medium that semi-permanently stores data therein and is readable by a device. Specific examples of the non-transitory computer-readable medium may include CD, DVD, hard disk, Blu-ray disk, USB, memory card, ROM, etc.

According to an embodiment, a method according to various embodiments disclosed in this document may be provided while being included in a computer program product. The computer program products may be traded between a seller and a purchaser as merchandise. The computer program products may be distributed in the form of a device readable storage medium (e.g., compact disc read only memory (CD-ROM) or distributed (e.g., downloaded or uploaded) online directly through an application store (e.g., Play Store™) or between two user devices (e.g., smartphones). In the case of online distribution, some of the computer program products (e.g., a downloadable app) may be at least transitorily stored in a device readable storage medium such as a server of a manufacturer, a server of the application store, or a memory of a relay server, or temporarily generated.

While the embodiments of the present disclosure have been illustrated and described above, the present disclosure is not limited to the aforementioned specific embodiments, various modifications may be made by a person with ordinary skill in the technical field to which the present disclosure pertains without departing from the subject matters of the present disclosure that are claimed in the claims, and these modifications should not be appreciated individually from the technical spirit or prospect of the present disclosure.

### EXPLANATION OF REFERENCE NUMERALS AND SYMBOLS

100: Electronic apparatus
110: Memory,
120: Communication interface
130: Processor
131: Captioning module
132: Frame selection module
133: Voice recognition module
134: Slide configuration module
200: Captioning server
300: Voice recognition server
400: Language processing server

1. An operation method of an electronic apparatus, comprising:
extracting a plurality of image frames and audio data constituting a video;
acquiring a first text for each image frame from the plurality of image frames;
selecting at least one main image frame among the plurality of image frames based on the first text;
acquiring a second text into which the audio data is converted for each time interval constituting the video; and
generating presentation data constituted by at least one slide based on the main image frame, a first text matching the main image frame, and a second text matching a time interval including the main image frame.

2. The operation method of an electronic apparatus of claim 1, wherein in the acquiring of the first text,
each of the plurality of image frames is input into a captioning model to acquire a first text corresponding to each image frame.

3. The operation method of an electronic apparatus of claim 1, wherein in the selecting of the main image frame,
the first text matching each of the plurality of image frames is analyzed based on reference data acquired according to a user input to calculate an importance of each of the plurality of image frames, and
at least one main image frame among the plurality of image frames is selected based on the importance.

4. The operation method of an electronic apparatus of claim 1, wherein the generating of the presentation data includes
acquiring a comprehensive text based on the first text and the second text matching the at least one main image frame; respectively,
dividing the comprehensive text into at least one sub text; and
generating slide configuration information including at least one slide matching the at least one sub text, respectively.

5. The operation method of an electronic apparatus of claim 4, wherein in the dividing of the comprehensive text into at least one sub text, the comprehensive text is divided into a plurality of sub texts based on a theme relevancy, a semantic connectivity, and a similarity of each sentence constituting the comprehensive text.

6. The operation method of an electronic apparatus of claim 4, wherein in the generating of the slide configuration information,
a main sentence is extracted from a sub text matching each slide,
at least one main image frame related to the sub text matching each slide is selected, and
each slide is arranged according to an order of each of at least one sub text within the comprehensive text, and each slide is configured based on the extracted main sentence and the selected main image frame.

7. The operation method of an electronic apparatus of claim 6, comprising:
providing feedback information for the slide configuration information based on the number of images within each slide according to the slide configuration information.

8. An operation method of an electronic apparatus performing communication with an image captioning server and a voice recognition server, comprising:
extracting a plurality of image frames and audio data constituting a video;
transmitting the plurality of image frames to the image captioning server, and acquiring a first text for each image frame according to a result of captioning performed by the image captioning server;
selecting at least one main image frame among the plurality of image frames based on the first text;
transmitting the audio data to the voice recognition server, and acquiring a second text into which the audio data is converted for each a time interval constituting the video according to a result of voice recognition performed by the voice recognition server; and
generating presentation data constituted by at least one slide based on the main image frame, a first text matching the main image frame, and a second text matching a time interval including the main image frame.

9. An electronic apparatus comprising:
a memory storing at least one instruction; and
a processor performing an operation method of claim 1 by executing the instruction.

10. A non-transitory computer readable medium storing at least one instruction which is executed by a processor an electronic apparatus and allows the electronic apparatus to perform an operation method of claim 1.
